(19) United States
(12) Patent Application Publication
(10) Pub. No.: US 2023/0368484 A1
(43) Pub. Date: Nov. 16, 2023

(54) DYNAMIC 360-DEGREE VIRTUAL SENSOR MAPPING

(71) Applicant: FACTION TECHNOLOGY, INC., South San Francisco, CA (US)

(72) Inventors: Barry Munsterteiger, Vancouver, WA (US); David Lombardi, Cincinnati, OH (US); Ain McKendrick, Redwood City, CA (US); Peter Schmidt, Fredericksburg, TX (US); Andrea Mariotti, Pacifica, CA (US)

(21) Appl. No.: 18/316,119

(22) Filed: May 11, 2023

Related U.S. Application Data
(60) Provisional application No. 63/364,521, filed on May 11, 2022.

(51) Int. Cl. G06V 10/10; G06T 17/00; G06T 3/00; G06V 10/25

(52) U.S. Cl. CPC G06V 10/16; G06T 3/0093; G06T 17/00; G06V 10/25

(57) ABSTRACT

In an example, a method of dynamic virtual sensor mapping includes receiving a request to obtain a first view associated with a system. The first view is associated with a first distortion key. The method includes obtaining video sensor data from multiple video sensors associated with the system. The method includes applying the first distortion key to the video sensor data to obtain distorted video sensor data. The method includes obtaining additional sensor data from multiple additional sensors associated with the system. The method includes applying the first distortion key to the additional sensor data to obtain distorted additional sensor data. The method includes combining the distorted video sensor data together with the distorted additional sensor data to generate combined distorted video data. The method includes transmitting the combined distorted video data.

### CROSS-REFERENCE TO RELATED APPLICATION

This application claims the benefit of and priority to U.S. Provisional App. No. 63/364,521 filed May 11, 2022, which is incorporated herein by reference.

### FIELD

The present disclosure is generally related to dynamic 360-degree virtual sensor mapping, specifically related to dynamic 360-degree virtual sensor mapping of driverless vehicles.

### BACKGROUND

Unless otherwise indicated herein, the materials described herein are not prior art to the claims in the present application and are not admitted to be prior art by inclusion in this section.

Autonomous vehicles are designed to be operated without input from a human operator. Some operations of autonomous vehicles may include obtaining sensor data and transmitting the sensor data to another location for processing and/or decision-making. Some sensor data may include video data and/or a video stream of data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

In an embodiment, a method of dynamic virtual sensor mapping includes receiving a request to obtain a first view associated with a system. The first view is associated with a first distortion key. The method includes obtaining video sensor data from multiple video sensors associated with the system. The method includes applying the first distortion key to the video sensor data to obtain distorted video sensor data. The method includes obtaining additional sensor data from multiple additional sensors associated with the system. The method includes applying the first distortion key to the additional sensor data to obtain distorted additional sensor data. The method includes combining the distorted video sensor data together with the distorted additional sensor data to generate combined distorted video data. The method includes transmitting the combined distorted video data.

In another embodiment, a method includes unwrapping a 3D model modeled as surrounding a driverless vehicle to generate a UV map. The method includes receiving wide-angle video data captured by one or more video sensors of the driverless vehicle. The method includes receiving a request for a primary view in the wide-angle video data from a requestor. The method includes warping the UV map to expand a region corresponding to the primary view. The method includes, for each image in a sequence of images in the wide-angle video data, painting the image onto the warped UV map to generate a warped 2D texture map in which a relative size of the primary view is greater in the warped 2D texture map than in the image. The method includes transmitting warped video data comprising a sequence of warped 2D texture maps to the requestor.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example dynamic virtual sensor mapping system;

FIG. 2 illustrates a block diagram of an example system that may be included in the dynamic virtual sensor mapping system of FIG. 1;

FIGS. 3A-3C illustrate an example UV map, 3D model, and 2D texture map associated with an example driverless vehicle;

FIGS. 4A-4C illustrate an example linearized UV map, the 3D model of FIG. 3B, and linearized 2D texture map associated with the driverless vehicle of FIGS. 3A-3C;

FIGS. 5A-5C illustrate an example warped UV map, the 3D model of FIG. 3B, and warped 2D texture map associated with the driverless vehicle of FIGS. 3A-3C;

FIG. 6 depicts a change of size of a requested primary view responsive to the warping of FIGS. 5A-5C;

FIGS. 7A-7C illustrate an example warped UV map, the 3D model of FIG. 3B, and warped 2D texture map associated with the driverless vehicle of FIGS. 3A-3C;

FIG. 8 illustrates an example teleoperator view that may be presented to a teleoperator;

FIG. 9 illustrates another example teleoperator view that includes embedded sensor data;

FIG. 10 is a flowchart of an example method for dynamic virtual sensor mapping; and

FIG. 11 illustrates a block diagram of an example computing system.

### DESCRIPTION OF EMBODIMENTS

Recent developments in technology have begun to enable operation of driverless vehicles. A driverless vehicle may include any vehicle in which an operator is not present, such as an autonomous vehicle, a remote-controlled vehicle (e.g., an RC car, a drone, etc.), and/or other driverless vehicles. Autonomous vehicles may be designed to operate independent of human input. For example, an autonomous vehicle may be capable of accelerating, braking, turning, obeying traffic laws, etc., all without the input from a human operator. In some circumstances, operation of driverless vehicles may include a combination of autonomous operations and human operator input, such as teleoperations. In the present disclosure, teleoperations may include input from a teleoperator, who may provide operational input to an autonomous vehicle using a variety of controls remote from the autonomous vehicle.

In some circumstances, teleoperations of driverless vehicles may include the teleoperator making decisions for the driverless vehicle based on visual information, such as a stream of video from one or more video sensors. For example, based on video sensor data received from a video sensor onboard the driverless vehicle, a teleoperator may issue one or more commands to the driverless vehicle to avoid a hazard in the path of the driverless vehicle.

Video sensor data that may be used in conjunction with teleoperation decisions may have a latency below a threshold latency to be useful. For example, video sensor data provided to a teleoperator with a latency above the threshold latency may not provide enough time for the teleoperator to provide operational commands to the driverless vehicle before a teleoperation situation is encountered. Alternatively, or additionally, the video sensor data that may be used in conjunction with teleoperation decisions may include a pixel density greater than a threshold density or quality as part of the display thereof to be useful. For example, video sensor data provided to a teleoperator with a pixel density less than the threshold density may be fuzzy, grainy, distorted, or otherwise degraded such that a teleoperator may experience difficulty in identifying a driving environment and/or potential hazards.

In general, teleoperations may benefit from video sensor data that includes an image quality in which objects are distinguishable and that is delivered without significant latency. For example, a teleoperator may have a limited reaction time to provide operational commands to a driverless vehicle and the teleoperator may be limited in making operational decisions based on what the teleoperator is able to observe from the video sensor data.

In some circumstances, a driverless vehicle may include multiple video sensors, each of which may be configured to produce video sensor data. In some circumstances, each video sensor may generate an amount of video sensor data that may be greater than or equal to a transmission rate between the driverless vehicle and the teleoperator. For example, one video sensor may be configured to produce video sensor data including a 6k resolution. In such instances, it may be difficult or impractical to transmit video feeds from each of the video sensors simultaneously for display to a teleoperator.

In some circumstances, a driverless vehicle may include additional sensors which may produce additional sensor data. The additional sensor data may benefit the teleoperator providing operational decisions to a driverless vehicle. In some circumstances, the additional sensor data may be transmitted separate from the video sensor data, which may include additional communication channels and/or more bandwidth to transmit both the video sensor data and the additional sensor data.

In some circumstances, a teleoperator may use a workstation that may be configured to facilitate or perform teleoperations. For example, the teleoperation workstation may include computing devices that may be capable of running multiple video feeds simultaneously and/or displaying multiple video feeds in a semi-circular or circular environment. In some circumstances, a teleoperation workstation may include high costs in setting up and maintaining. For example, a teleoperation workstation may include multiple monitors, processing devices, graphics rendering components, and/or additional computing components that may be configured to work together in displaying a driverless vehicle operating environment for a teleoperator to observe and/or interact with.

Aspects of the present disclosure address these and other shortcomings of prior approaches by providing dynamic 360-degree virtual sensor mapping for driverless vehicles, or dynamic virtual sensor mapping. In some embodiments, the dynamic virtual sensor mapping may produce video sensor data that may meet or exceed a quality threshold and/or a latency threshold for teleoperations. In some embodiments, the dynamic virtual sensor mapping may include a focal point which may include a pixel density that may be greater than non-focal point portions of a video feed. Including a focal point may enable the dynamic virtual sensor mapping to maintain video sensor data above a threshold density or quality while also maintaining the transmission of the video sensor data below a threshold latency. For example, the transmitted video feed may be compressed relative to the video sensor data such that less data is transmitted in conjunction with the video feed to reduce latency.

In some circumstances, one or more embodiments of the present disclosure may be configured to include additional sensor data from one or more additional sensors (e.g., in addition to video sensor data from one or more video sensors). For example, the dynamic virtual sensor mapping may include raw data such as radar data, vehicle speed data, vehicle directional data, objects in motion data relative to the vehicle, etc., and/or processed data such as path routing data, vehicle trajectory data, etc. In these and other embodiments, the dynamic virtual sensor mapping may include combining or merging the video sensor data and the additional sensor data into a single video feed that may be transmitted from a driverless vehicle to a teleoperator.

In some circumstances, one or more embodiments of the present disclosure may reduce the high costs associated with a teleoperation workstation as some or all of the video editing and/or transformation associated with teleoperations may be performed prior to the transmission of the video feed to the teleoperator. For example, a teleoperation workstation associated with dynamic virtual sensor mapping may include a computing device, such as a desktop computer, a laptop computer, a tablet computer, and/or other computing devices without the expense of or need for the equipment required for traditional teleoperation workstations.

Embodiments of the present disclosure will be explained with reference to the accompanying drawings. As described in the present disclosure, the use of the terms first, second, etc., are intended to illustrate generic adjectives and not imply ordinality, unless explicitly described as such.

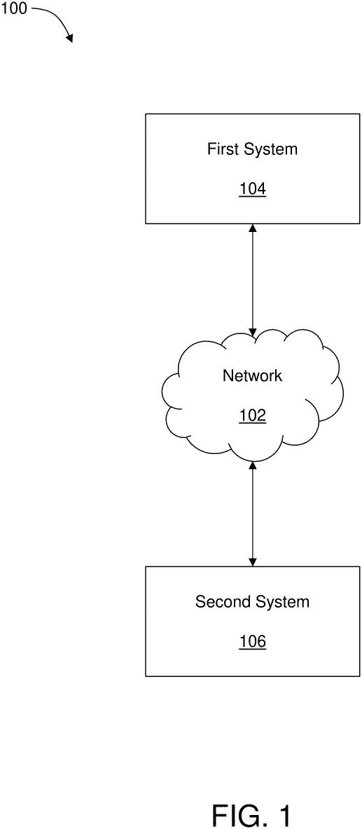

FIG. 1 illustrates a block diagram of an example dynamic virtual sensor mapping system 100, in accordance with at least one embodiment of the present disclosure. In some embodiments, the dynamic virtual sensor mapping system 100 may include a network 102, a first system 104, and a second system 106.

In some embodiments, the network 102 may be configured to communicatively couple the first system 104 and the second system 106. In some embodiments, the network 102 may be any network or configuration of networks configured to send and receive communications between systems. In some embodiments, the network 102 may include a wired network, an optical network, and/or a wireless network, and may include numerous different configurations, including multiple different types of networks, network connections, and protocols to communicatively couple the first system 104 and the second system 106 in the dynamic virtual sensor mapping system 100. For example, the network 102 may include Wi-Fi transmissions, cellular communications such as 4G, 5G, or LTE, various Wide Area Networks (WANs), etc.

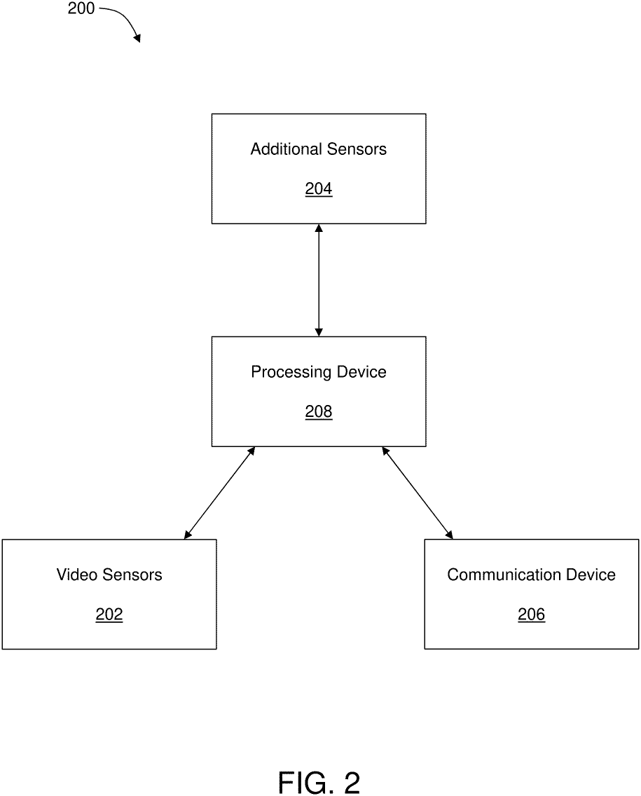

In some embodiments, the first system 104 may include a system of sensors, processing devices, memory storage devices, communication devices, and the like. In some embodiments, the first system 104 may be included in a driverless vehicle. For example, the first system 104 may include components included in a driverless vehicle that may enable the driverless vehicle to operate autonomously and/or operate using input from a teleoperator. In some embodiments, the driverless vehicle may be configured to obtain sensor data, perform one or more processing tasks on or using the obtained sensor data, and transmit the processed sensor data, such as to the second system 106 via the network 102. Additional details and/or examples related to the first system 104 are described with respect to FIG. 2 herein. Alternatively, or additionally, the first system 104 may be included in other driverless vehicle or non-driverless vehicle implementations, which may include various forms of teleoperation including proprietary systems such as TELEASSIST®, various security installments, telepresence implementations, and the like.

In some embodiments, the second system 106 may include processing devices, display devices, user input devices, memory storage devices, communication devices, and the like. In some embodiments, the second system 106 may be included in a teleoperation workstation. Alternatively, or additionally, the second system 106 may be included in any device or system that may be communicatively coupled to the first system 104. For example, the second system 106 may be included in a security system, a telepresence system, and/or various teleoperation systems which may include proprietary systems such as TELEASSIST®.

In some embodiments, all of the devices included in the second system 106 may be disposed in a single device, such as a tablet computer, a laptop computer, and the like. Alternatively, or additionally, the devices included in the second system 106 may be disposed in multiple hardware devices, such as one or more monitors, one or more computing devices which may include one or more servers, various user input devices, etc.

In some embodiments, the first system 104 may be configured to receive requests, operational commands, and/or other inputs from the second system 106, such as teleoperation commands from a teleoperator. In some embodiments, the first system 104 may cause the second system 106 to adjust one or more sensors to a focal point, as designated by the second system 106, such as through user input from the teleoperator via the teleoperation workstation. In these and other embodiments, operations of one or more components of the first system 104 may be modified in response to received input from the second system 106. For example, the second system 106 may request a focal point directed out the side of the driverless vehicle and the system of sensors and/or the processing devices of the first system 104 may be configured to obtain and transmit a video feed including a focal point directed out the side of the driverless vehicle to the second system 106.

Modifications, additions, or omissions may be made to the dynamic virtual sensor mapping system without departing from the scope of the present disclosure. For example, in some embodiments, the dynamic virtual sensor mapping system may include any number of other components that may not be explicitly illustrated or described.

FIG. 2 illustrates a block diagram of an example system 200 that may be included in the dynamic virtual sensor mapping system 100 of FIG. 1, in accordance with at least one embodiment of the present disclosure. For example, the system 200 of FIG. 2 may be the same or similar as the first system 104 of FIG. 1. In some embodiments, the system 200 may include one or more video sensors 202, one or more additional sensors 204, a communication device 206, and/or a processing device 208.

In some embodiments, the video sensors 202 may be communicatively coupled to the processing device 208 and may be configured to transmit video sensor data to the processing device 208, as described herein. Alternatively, or additionally, the additional sensors 204 may be communicatively coupled to the processing device 208 and may be configured to transmit additional sensor data to the processing device 208, as described herein.

In some embodiments, the communication device 206 may be communicatively coupled to the processing device 208. In some embodiments, the communication device 206 may receive communications from another system and transmit the received communications to the processing device 208. For example, the communication device 206 may receive operational commands from the teleoperator that may be transmitted to the processing device 208. Alternatively, or additionally, the communication device 206 may transmit communications from the system 200 to another device. For example, upon receiving a video stream from the processing device 208, the communication device 206 may transmit the video stream to another device or system, such as a teleoperation workstation.

In some embodiments, the video sensors 202 may be configured to obtain video sensor data associated with the system 200 or other systems herein, such as the first system 104 of FIG. 1. In some embodiments, the associated system 200 may include a driverless vehicle. Although discussed herein in relation to a driverless vehicle, it will be appreciated that other associated systems are also contemplated, which may include various forms of teleoperation including proprietary systems such as TELEASSIST®, various security installments, telepresence implementations, or the like. One or more of the video sensors 202 may include a video camera configured to obtain motion pictures. In some embodiments, the video sensors 202 may be arranged on the driverless vehicle such that one or more of the video sensors 202 is directed in an outward direction from the driverless vehicle. For example, a first video sensor 202 may be directed in a forward direction from the driverless vehicle, a second video sensor 202 may be directed in a backward direction from the driverless vehicle, a third video sensor 202 may be directed in a side direction from the driverless vehicle, such as in passenger-side direction, and a fourth video sensor 202 may be directed in another side direction from the driverless vehicle, such as in driver-side direction, where each direction may be relative to the driverless vehicle. To be clear, while a driverless vehicle may or may not have a driver and/or any passengers, the terms “passenger-side direction” and “drive-side direction” may nevertheless be applied to refer to corresponding directions. For example, in countries such as the United States in which vehicles generally have a left side (when facing forward) that is the driver side and a right side (when facing forward) that is the passenger side, the terms “driver-side direction” and “passenger-side direction” respectively refer to the left side direction and the right side direction, even for a driverless vehicle.

Alternatively, or additionally, the video sensors 202 may be arranged such that one or more video sensors 202 may be configured to overlap their respective fields of view. For example, if each of the first, second, third, and fourth video sensors 202 mentioned above has a FOV greater than 90 degrees and is arranged at 90 degree intervals around the driverless vehicle facing directly outward, then the fields of view of each adjacent pair of the first, second, third, and fourth video sensors 202 would overlap. Alternatively or additionally, and continuing with the previous example, a fifth video sensor 202 may be arranged to face a direction between the first video sensor 202 direction and the second video sensor 202 direction with a FOV that (at least at its angular extremes) overlaps fields of view of the first and second video sensors 202, a sixth video sensor 202 may be arranged to face a direction between the second video sensor 202 direction and the third video sensor 202 direction with a FOV that (at least at its angular extremes) overlaps fields of view of the second and third video sensors 202, a seventh video sensor 202 may be arranged to face a direction between the third video sensor 202 direction and the fourth video sensor 202 direction with a FOV that (at least at its angular extremes) overlaps fields of view of the third and fourth video sensors 202, and an eighth video sensor 202 may be arranged to face a direction between the fourth video sensor 202 direction and the first video sensor 202 direction with a FOV that (at least at its angular extremes) overlaps fields of view of the fourth and first video sensors 202.

The number of video sensors 202 that may be included in the system 200 may vary and/or may be based on the driverless vehicle and/or the dynamic sensor mapping system 100. For example, the system 200 may include one video sensor (e.g., a video sensor that may be configured to change direction based on input), or two, three, four, six, eight, fifteen, twenty, and/or any other amount of video sensors 202. In these and other embodiments, the number of video sensors 202 that may be included in the system 200 may be based on the FOV of the video sensors 202, the quality of the video sensor data, a threshold amount of overlap between two or more of the video sensors 202, and/or other characteristics of the system 200.

In some embodiments, the one or more additional sensors 204 may include any sensors that may be used by the processing device 208 to improve situational awareness associated with the operation of the driverless vehicle. In some embodiments, the additional sensors 204 may include one or more of an accelerometer, a gyroscope, a global positioning system (GPS) device, a radar device, a LIDAR device, a thermal infrared device, an ultrasonic device, or the like. In some embodiments, the one or more additional sensors 204 may produce additional sensor data that may be combined with the video sensor data by the processing device 208, such as for transmission and presentation to a teleoperator. For example, acceleration data, speed data, velocity data, location data, ranging data (e.g., distance to objects), routing data, object detection data, etc., may be obtained and/or transmitted to the processing device 208 for combination with the video sensor data.

In some embodiments, the video sensor data and/or the additional sensor data may be transmitted to the processing device 208 and the processing device 208 may use the video sensor data and/or the additional sensor data in dynamic virtual sensor mapping. The video sensor data may include 360-degree video data that may be associated with a driverless vehicle.

Some or all driverless vehicles may require remote human intervention for the foreseeable future. A 360° camera feed that is high enough resolution may be necessary for clear situational awareness for the remote human to make a decision. However, the bandwidth to send multiple high-resolution streams from a fleet of vehicles, or data pipeline into a data center to handle that amount of data, may be cost-prohibitive and/or non-existent at present.

Some embodiments herein include a method to create a single 360° camera feed (e.g., video data) by combining multiple camera feeds and optionally one or more sensor data sets into one data set that allows dynamic resolution prioritization based on where the focus is. This may be accomplished by expanding and compressing different parts of a corresponding camera feed canvas to allow for more pixels to be prioritized where a viewer is looking. This may be decoded on the client side in a method that preserves the position of imagery.

Accordingly, some embodiments result in a single data feed that gives a low resolution 360° overview around the driverless vehicle, but high-resolution wherever the human operator wishes to focus.

A common method of viewing around a vehicle, originally developed in the visual effects (VFX) industry, is to stitch multiple camera feeds into a 360° image or feed that is then projected onto a basic shape that approximates the space near a vehicle. The basic shape in some embodiments may be a lidar model of an immediate space or environment around the vehicle. Alternatively or additionally, the basic shape may include a semi-sphere (e.g., half sphere), semi-ellipsoid (e.g., half ellipsoid), or other suitable 3D shape having a planar lower surface generally parallel to and/or generally aligned to the ground. The planar lower surface may be circular (in the case of a semi-sphere), elliptical (in the case of a semi-ellipsoid), or other suitable 2D shape and centered on the driverless vehicle. The remainder of the semi-sphere or semi-ellipsoid (or other 3D shape) may form a dome around and over the driverless vehicle.

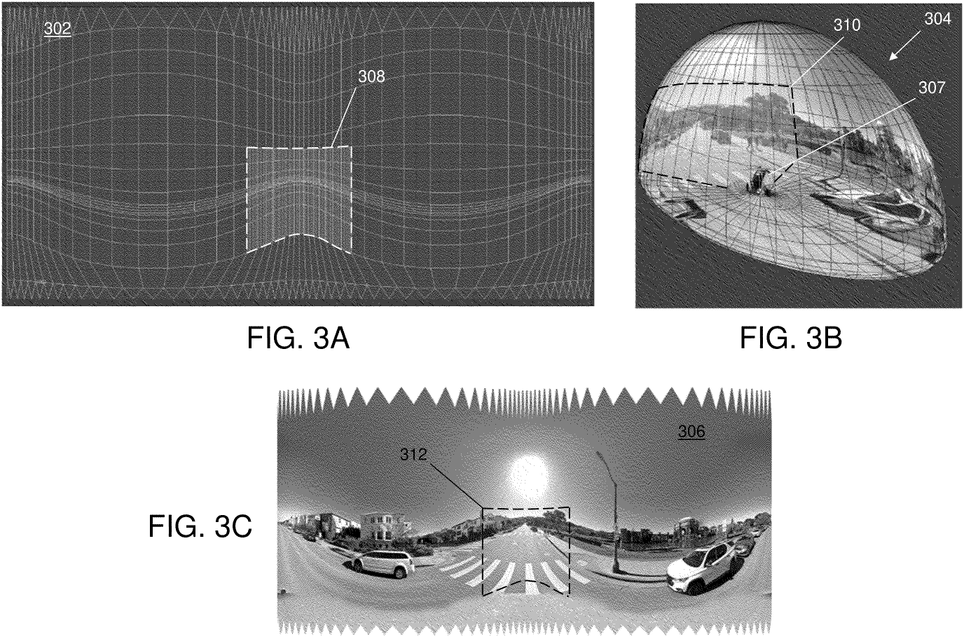

FIGS. 3A-3C illustrate an example UV map 302, 3D model 304, and 2D texture map 306 associated with an example driverless vehicle 307 (FIG. 3B only), arranged in accordance with at least one embodiment described herein. In more detail, the UV map 302 depicted in FIG. 3A is a flat surface representation of a 3D model 304 depicted in FIG. 3B generally surrounding the driverless vehicle 307. The UV map 302 of FIG. 3A may be generated by, e.g., unwrapping the 3D model 304 of FIG. 3B. The 2D texture map 306 of FIG. 3C may be generated by painting a 2D image, e.g., an image captured in a camera feed of the driverless vehicle 307, onto the UV map 302 of FIG. 3A. FIG. 3B further depicts the 2D image painted onto the 3D model 304 according to UV texture coordinates of the 2D texture map 306 of FIG. 3C.

The camera feed of the driverless vehicle 307, which may be a 360° camera feed or video data or other wide-angle camera feed or video data, may be generated by stitching together camera feeds from multiple different video sensors of the driverless vehicle 307. The 360° camera feed may include multiple sequential images, each of which may have been stitched together from multiple sequential images of the multiple different video sensors. For example, each image in the 360° camera feed may include a front image (from a front facing video sensor), a left image (from a left facing video sensor), a right image (from a right facing video sensor), and a rear image (from a rear facing video sensor) that have been stitched together. In these and other embodiments, a 2D texture map, such as the 2D texture map 306 of FIG. 3C or any of the other 2D texture maps described herein, may be generated for each image in the 360° camera feed. A series of sequential 2D texture maps together may form a video or camera feed that may be output to the teleoperator or other user, and may be referred to as, e.g., a texture map video or camera feed. Alternatively or additionally, images painted onto a 3D model (such as illustrated in FIG. 3B) may similarly be output in series to form a video or camera feed that may be output to the teleoperator or other user, and may be referred to as, e.g., a 3D model video or camera feed.

Returning to FIG. 3A, it also identifies a region 308 in the UV map 302 corresponding to a forward 90° FOV of the driverless vehicle 307 and may be referred to as the 2D forward 90° FOV 308. A corresponding region is designated at 310 in the 3D model 304 and may be referred to as the 3D forward 90° FOV 310. The 3D forward 90° FOV 310 is a 90° FOV of the portion of the surrounding environment generally directly in front of the driverless vehicle 307. The 2D forward 90° FOV 308 in the UV map 302 is a flattened representation of the 90° FOV of the portion of the surrounding environment generally directly in front of the driverless vehicle 307. Another corresponding region is designated at 312 in the 2D texture map 306 and may be referred to as the 2D image forward 90° FOV 312. The 2D image forward 90° FOV 312 in the 2D texture map 306 includes a portion of the 2D image captured in the 90° FOV directly in front of the driverless vehicle 307.

The 3D forward 90° FOV 310 and/or the corresponding 2D image forward 90° FOV 312 may be of most interest to a teleoperator driving the driverless vehicle 307 in many circumstances, including generally when the driverless vehicle 307 is moving forward. As illustrated in FIGS. 3A-3C, however, the 2D forward 90° FOV 308, the 3D forward 90° FOV 310, and the 2D image forward 90° FOV 312 each respectively occupies only a small area of the overall UV map 302, painted 3D model 304, or 2D texture map 306, which may make it difficult for a teleoperator to discern exactly what is going on in front of the driverless vehicle 307 within the surrounding environment present in the forward 90° FOV of the driverless vehicle 307.

The 2D image in the example of FIGS. 3A-3C may include images from multiple different video sensors stitched together (or from a single video sensor that is movable relative to the driverless vehicle 307 to generate views in different directions or from different relative positions) and/or may provide a 360° FOV around the driverless vehicle 307. As already indicated, however, one problem with a 360° camera feed, which may include a series of two or more 360° images such as that shown in FIG. 3C, is the significant bandwidth that would be required to transmit the 360° camera feed at high enough resolution to be useful. Consider the following. A raw 360° 2 K camera feed is efficient in terms of bandwidth, but only gives about 500 pixels for a 90° FOV; as such, it has insufficient resolution to be useful. On the other hand, a raw 360° 8 K camera feed gives about 2000 pixels for a 90° FOV, but requires too much transmission bandwidth for practical use. Regardless of the exact pixel count, a raw 360° 2 K camera feed is generally efficient in terms of bandwidth but has insufficient resolution to be useful, while a raw 360° 8 K camera feed generally has sufficient resolution but requires too much transmission bandwidth for practical use.

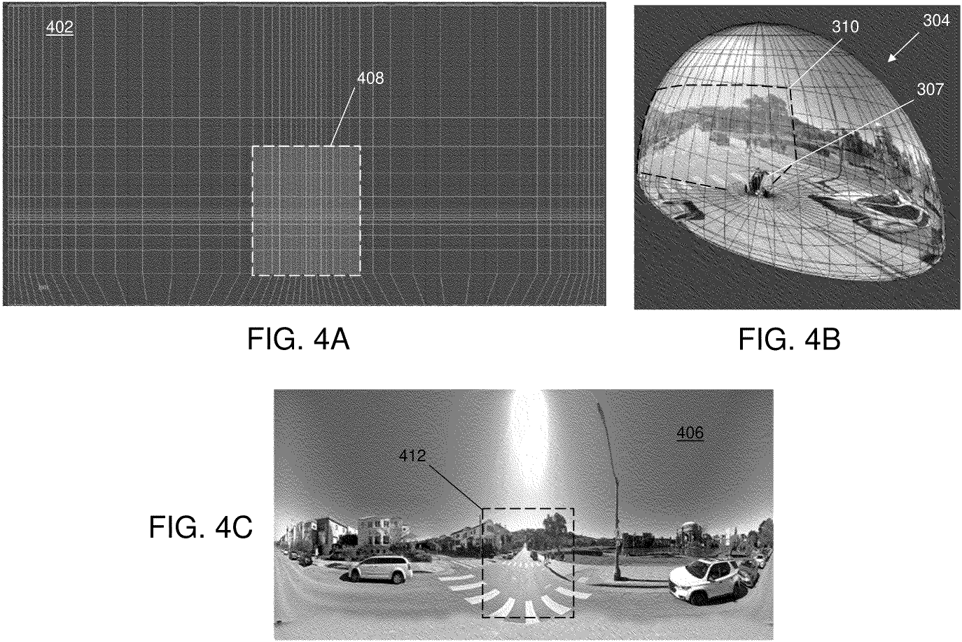

Accordingly, some embodiments herein may warp the UV map and corresponding 2D texture map in a given region, such as regions 308, 312 in FIGS. 3A and 3C, dedicated to a primary view requested or desired by, e.g., a teleoperator. Warping the UV map may include a preparatory linearization step. For example, FIGS. 4A-4C illustrate an example linearized UV map 402, the 3D model 304, and linearized 2D texture map 406 associated with the driverless vehicle 307 of FIGS. 3A-3C, arranged in accordance with at least one embodiment described herein. The linearized UV map 402 depicted in FIG. 4A may be generated by linearizing the grid of the UV map 302 of FIG. 3A. The linearized 2D texture map 406 of FIG. 4C may be generated by painting the 2D image onto the linearized UV map 402 of FIG. 4A. FIG. 4A also identifies a linearized version of the 2D forward 90° FOV 308 of FIG. 3A, which may be referred to as a linearized 2D forward 90° FOV 408. FIG. 4C also identifies a linearized version of the 2D image forward 90° FOV 312 of FIG. 3C, which may be referred to as a linearized 2D image forward 90° FOV 412.

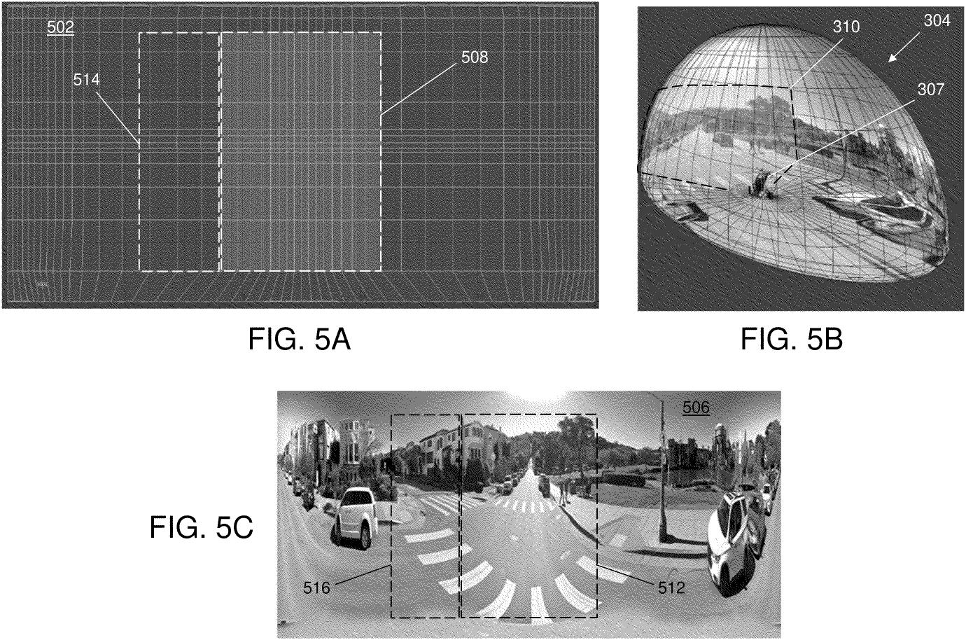

In some embodiments, and following linearization (or omitting linearization in some embodiments), the grid of the UV map and the 2D texture map may be warped to focus in on, blow up, or otherwise emphasize and make more prominent (e.g., with increased pixel density) the requested primary view. In this particular example, the grid of the linearized UV map 402 may be warped and the warped UV map may then have the 2D image painted thereon to generate a warped 2D texture map. FIGS. 5A-5C illustrate an example warped UV map 502, the 3D model 304, and warped 2D texture map 506 associated with the driverless vehicle 307 of FIGS. 3A-3C, arranged in accordance with at least one embodiment described herein. The warped UV map 502 depicted in FIG. 5A may be generated by warping the linearized UV map 402 of FIG. 4A to increase the relative size of the requested primary view. In this case, the requested primary view is the view corresponding to the 2D forward 90° FOV 408 of FIG. 4A. Thus, the UV map 402 of FIG. 4A may be warped to increase the relative size of the 2D forward 90° FOV 408 of FIG. 4A to a warped 2D forward 90° FOV 508 in the warped UV map 502 of FIG. 5A. The warped 2D texture map 506 of FIG. 5C may be generated by painting the 2D image onto the warped UV map 502 of FIG. 5A, resulting in a warped 2D image forward 90° FOV 512.

FIG. 5A also identifies a region 514 in the warped UV map 502 corresponding to a left (or driver side) 90° FOV of the driverless vehicle 307 and may be referred to as the 2D left 90° FOV 514. The 2D left 90° FOV 514 in the warped UV map 502 is a flattened, linearized, and warped (primarily vertically) representation of the 90° FOV of the portion of the surrounding environment generally directly to the left of the driverless vehicle 307. Another corresponding region (corresponding to the left 90° FOV 514 of FIG. 5A) is designated at 516 in the warped 2D texture map 506 of FIG. 5C and may be referred to as the 2D image left 90° FOV 516. The 2D image left 90° FOV 516 in the warped 2D texture map 506 includes a portion of the 2D image captured in the 90° FOV directly left of the driverless vehicle 307.

As can be seen from FIGS. 4A-5C, warping the UV map 402 and 2D texture map 406 compresses unimportant image or video data (e.g., directly above or below the FOVs 408, 412 and to the sides, particularly at the extreme sides) to much fewer pixels at the upper and lower edges and left and right edges of the resulting warped UV map 502 and warped 2D texture map 506. This compression of the unimportant image or video data arises from expanding the requested primary view, which in this case is the forward 90° FOV of the driverless vehicle 307. As a result, the forward 90° FOV of the driverless vehicle 307 occupies a much larger portion (e.g., the warped 2D image forward 90° FOV 512 of the warped 2D texture map 506 of FIG. 5C) of the resulting warped image (e.g., the warped 2D texture map 506) that is presented to the teleoperator or other user compared to the unwarped image (e.g., the linearized 2D texture map 406 of FIG. 4C). The warped image (e.g., the warped 2D texture map 506) may have a pixel density similar to that of an 8K image stream in the focused area (e.g., the warped 2D image forward 90° FOV 512) but for only the bandwidth of or close to a 2K image stream.

While in this example the expansion and compression is applied both vertically and horizontally, in other embodiments the expansion and compression may be applied only vertically or only horizontally (or more generally only in a first direction, only in a second direction, only in a third direction, or the like). For example, the expansion and compression may be applied only vertically to expand a vertical FOV that may always be of interest to teleoperators while vertically compressing unimportant regions such as a bottom portion of the video data (which may include body/paintwork of the driverless vehicle) and/or a top portion of the video data (which may include sky or other objects that are vertically well outside a region of relevance to the driverless vehicle).

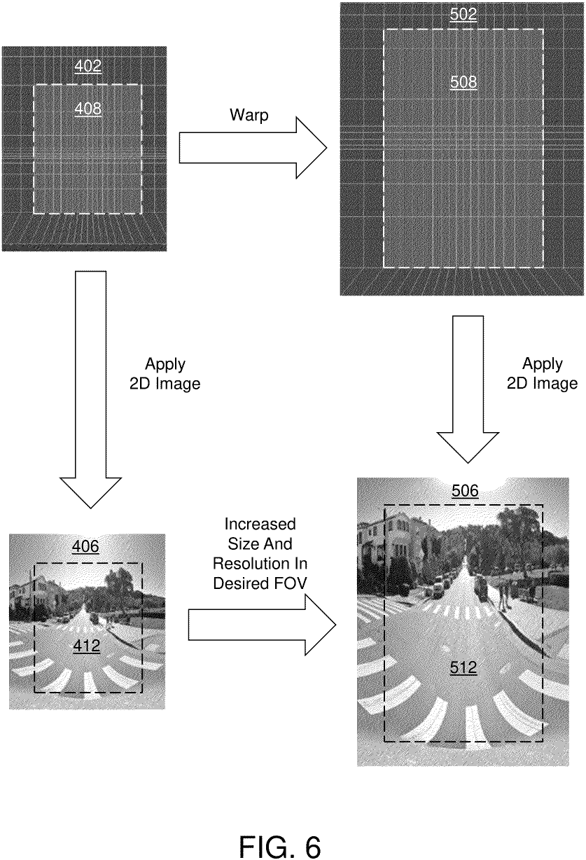

FIG. 6 depicts the change of size of the requested primary view responsive to the warping, arranged in accordance with at least on embodiment described herein. As illustrated, warping the linearized UV map 402 to generate the warped UV map 502 may include expanding the spacing (both horizontally and vertically) between the UV map 402 grid lines within the 2D forward 90° FOV 408 (which corresponds to the requested primary view) while compressing the spacing (both horizontally and vertically) between the UV map 402 grid lines that are outside the 2D forward 90° FOV 408. As a result of this warping and application of the 2D image, the relative size of the focused area in the image (e.g., the linearized 2D texture map 406 or the warped 2D texture map 506) presented to the teleoperator or other user is much larger after the warping. Specifically in this example, the relative size of the warped 2D image forward 90° FOV 512 in the 2D texture map 506 is much larger than the relative size of the 2D image forward 90° FOV 412 in the 2D texture map 406. This increased size (with increased pixel density) may give the teleoperator or other user sufficient resolution to ascertain what is occurring in the environment of the driverless vehicle 307 in the direction of the primary requested view.

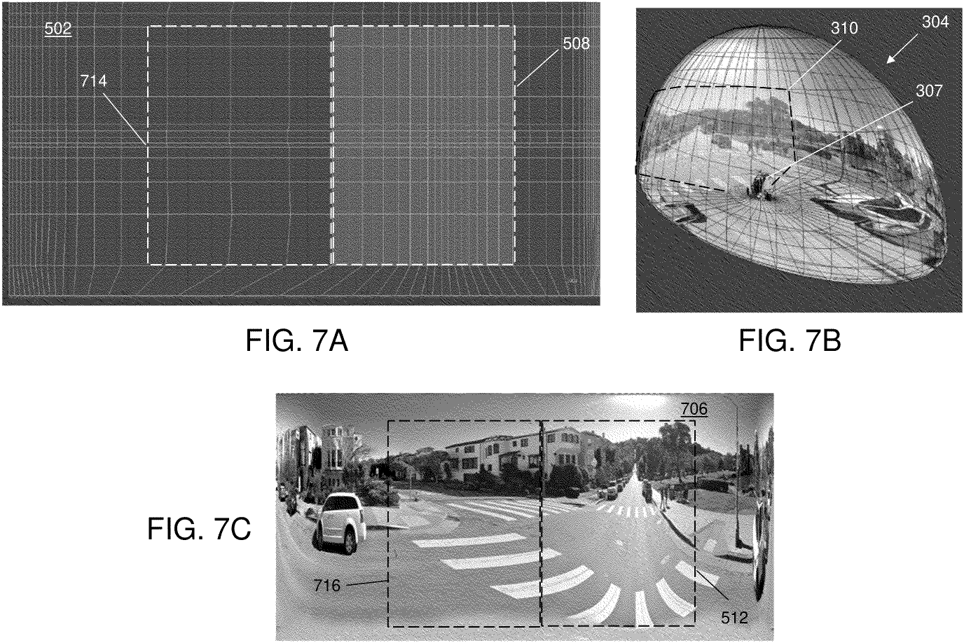

Some embodiments herein also permit adding an area of focus or changing the area of focus in the image (or environment surrounding the driverless vehicle 307). An example of adding an area of focus will be discussed in the context of FIGS. 7A-7C, which illustrate an example warped UV map 702, the 3D model 304, and warped 2D texture map 706 associated with the driverless vehicle 307 of FIGS. 3A-3C, arranged in accordance with at least one embodiment described herein. FIGS. 7A-7C differ from FIGS. 5A-5C in that in FIGS. 7A-7C, the teleoperator or other user has requested an additional focus on the left (or driver side) 90° FOV of the driverless vehicle 307.

The warped UV map 702 depicted in FIG. 7A may be generated by further warping the warped UV map 502 of FIG. 5A to increase the relative size of the additional requested view or area of focus. In this case, the additional requested view or area of focus is the left 90° FOV of the driverless vehicle 307 corresponding to the 2D left 90° FOV 514 of FIG. 5A. Thus, the warped UV map 502 of FIG. 5A may be further warped to increase the relative size of the 2D left 90° FOV 514 of FIG. 5A to a warped 2D left 90° FOV 714 in the warped UV map 702 of FIG. 5A. FIG. 7A depicts both the warped 2D left 90° FOV 714 as well as the warped 2D forward 90° FOV 508 (which itself may experience further warping compared to FIG. 5A). The warped 2D texture map 706 of FIG. 7C may be generated by painting the 2D image onto the warped UV map 702 of FIG. 7A, resulting in a warped 2D left 90° FOV 716 next to the warped 2D image forward 90° FOV 512.

As can be seen from FIGS. 5A-5C and 7A-7C, further warping the warped UV map 502 and 2D texture map 706 further squeezes unimportant image or video data (e.g., to the left side of the 2D left 90° FOV 714 and to the right side of the warped 2D forward 90° FOV 508, particularly at the extremes of these sides) to even fewer pixels at the left and right edges of the resulting warped UV map 702 and warped 2D texture map 706. This compression of the unimportant image or video data arises from expanding the requested primary view(s), which in this case is the forward 90° FOV and the left 90° FOV of the driverless vehicle 307. As a result, the forward 90° FOV and the left 90° FOV of the driverless vehicle 307 occupy much larger portions (e.g., the warped 2D image left 90° FOV 716 and warped 2D image forward 90° FOV 512 of the warped 2D texture map 706 of FIG. 7C) of the resulting warped image (e.g., the warped 2D texture map 706) that is presented to the teleoperator or other user compared to the unwarped image (e.g., the linearized 2D texture map 406 of FIG. 4C). The warped image (e.g., the warped 2D texture map 706) may have a pixel density similar to that of an 8K image stream in the focused areas (e.g., the warped 2D image left 90° FOV 716 and the warped 2D image forward 90° FOV 512) but for only the bandwidth of or close to a 2K image stream.

Rather than adding the left 90° FOV (or other additional FOV) as an area of focus in combination with the existing area of focus for the forward 90° FOV (or other initial FOV), the left 90° FOV (or other additional FOV) may instead be implemented as an area of focus in place of the existing area of focus for the forward 90° FOV. In this example, the warping to focus on the left 90° FOV described with respect to FIGS. 7A-7C may be applied to, e.g., the linearized UV map 402 and linearized 2D texture map 406 of FIGS. 4A and 4C rather than to the warped UV map 502 and warped 2D texture map 506 of FIGS. 5A and 5C.

In some embodiments, responding to a request to add an area of focus or change an area of focus may cause a brief moment where the teleoperator or other user sees a low resolution view of the warped 2D image left 90° FOV 716 before the new warp updates but the teleoperator or other user may still have a feed (albeit low resolution in this area) during this brief moment. Each of the source (e.g., the driverless vehicle or first system) and client (e.g., teleoperator workstation or second system) may update the grid of their respective UV maps so that even though the image is being warped (e.g., the 2D texture map), image details (or pixels) always lay back onto (or map to) the 3D model 304 in the appropriate positions.

In some embodiments, each potential requested view (e.g., front FOV, left FOV, right FOV, rear FOV, and/or other views) may be associated with a corresponding distortion key to effect the warping for a given requested view as described above. For example, a first distortion key may be associated with the driverless vehicle’s front FOV, a second distortion key may be associated with the driverless vehicle’s rear FOV, and so forth. In these and other embodiments, each distortion key may be associated with a different corresponding video sensor of the driverless vehicle. For example, the first distortion key may be associated with a first camera, the second distortion key may be associated with a second camera, and so forth. Each distortion key associated with each sensor may be used to generate a corresponding image with one corresponding area of focus (e.g., a corresponding warped 2D texture map such as the warped 2D texture map 506 of FIG. 5C) as described herein. Alternatively, two distortion keys, each associated with a different one of two sensors, may be simultaneously used to generate a corresponding image with two corresponding areas of focus (e.g., a corresponding warped 2D texture map with two corresponding areas of focus such as the warped 2D texture map 706 of FIG. 7C). The term “distortion key” as used herein may refer to the processing, manipulation (e.g., linearization), distortion, warping, and/or other techniques that may be used on or applied to video data from a given video sensor (or to 360° video data that includes the video data from the given video sensor) such that a desired area (or areas) of focus is (are) generated. In some embodiments, each distortion key is static and/or may be predetermined or pre-computed. In other embodiments, distortion keys may be generated on the fly, fluidly, or the like.

In some embodiments, the requested view (or area of focus) may be changed by changing the distortion keys. For example, a teleoperator may determine that a side view may be beneficial and may transmit a request for the driverless vehicle to apply the distortion key associated with the desired side view to the driverless vehicle, and the processing device 208 of the driverless vehicle may apply the distortion key to the 360° video data to output warped video data with the desired view or area of focus. In some embodiments, the distortion keys may be stored local to the driverless vehicle, such as in a data storage associated with the driverless vehicle. For example, a first distortion key may be stored in a data storage associated with the driverless vehicle (e.g., which may include a local data storage) such that in instances in which a request for a first view associated with the first distortion key is received, the driverless vehicle may obtain the first distortion key from the data storage and may apply the first distortion key to generate the warped video data with the first view.

In these and other embodiments, there may be any number of distortion keys such that a teleoperator may adjust the requested view to any direction (as in FIGS. 5A-5C) or combination of directions (as in FIGS. 7A-7C) relative to the driverless vehicle. In some embodiments, a transition from a first requested view to a second requested view (e.g., such as by receiving and/or applying a second distortion key to instead of a first distortion key) may include a pan from the first requested view to the second requested view. For example, the transition from the first requested view to the second requested view may include a substantially smooth pan from the first requested view to the second requested view. Alternatively, or additionally, the transition from the first requested view to the second requested view may include a cut from the first requested view to the second requested view. For example, the transition from the first requested view to the second requested view may include an abrupt transition from the first requested view to the second requested view.

In these and other embodiments, the teleoperator may request an updated requested view (e.g., by transmitting a request to apply a new distortion key to the driverless vehicle) at any time during operation of the driverless vehicle. For example, an updated requested view may occur before the driverless vehicle is in motion, during motion and/or operation of the driverless vehicle, and/or after a driving task may be completed.

In some embodiments, the processing device 208 may be configured to generate a focused video feed based on the corresponding UV map. For example, the processing device 208 may obtain the 360° video data (e.g., by receiving video data from multiple video sensors and stitching it together), generate a UV map (such as the UV map 302), optionally linearize the generated UV map (e.g., to generate the linearized UV map 402), warp the generated and/or linearized UV map (e.g., to generate the warped UV map 502 and/or the warped UV map 702), and paint the warped UV map sequentially with each image in the 360° video data to generate a focused video feed, e.g., a texture map video feed of 2D texture maps with an area of focus or requested view in each of the 2D texture maps in the feed. Each image in the focused video feed may include the requested primary view or area of focus that has been enlarged compared to surrounding areas as generally described with respect to FIGS. 5A-5C and 7A-7C. Alternatively, or additionally, the focused view feed may include the requested view by itself (e.g., from a single one of the video sensors and not in a warped form) and an additional video image that may be adjacent to (e.g., above and/or below) the requested view.

In some embodiments, the processing device 208 may be configured to generate one or more wide-angle video feeds that may be in addition, or in the alternative to a focused video feed. For example, the processing device 208 may obtain a wide-angle video feed (e.g., from a single wide-angle video sensor and/or by stitching together the video feeds from two or more video sensors). In an example, a front wide-angle video feed may include an approximate 180-degree FOV relative to the front of the driverless vehicle and the focused video feed may include an approximate 60-degree FOV relative to the front of the driverless vehicle, where the focused video feed may be within the front wide-angle video feed. The FOV associated with each of the wide-angle video feed and the focused video feed in the foregoing example may be greater or less than the examples given, and/or the FOV of the focused video feed may selected or modified by teleoperation commands from the teleoperator.

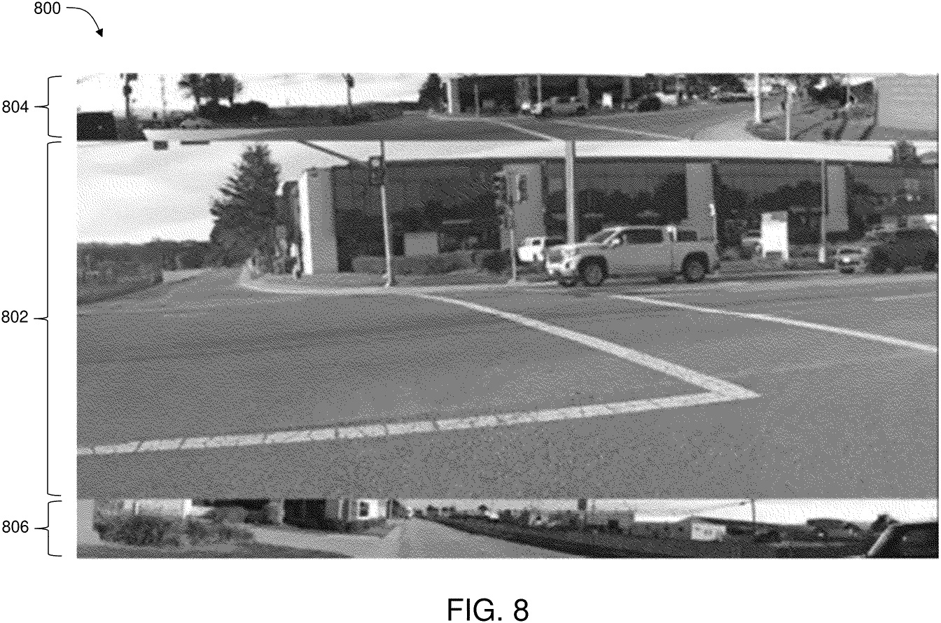

FIG. 8 illustrates an example teleoperator view 800 that may be presented to a teleoperator, arranged in accordance with at least one embodiment described herein. The teleoperator view 800 may include multiple views, including one or more of a focused view 802, a first wide-angle view 804, and/or a second wide-angle view 806.

The focused view 802 may include a primary requested view and/or area of focus as described herein and/or a view from a single video sensor of a driverless vehicle. In this particular example, the focused view 802 includes a view from a single video sensor of a driverless vehicle. The wide-angle views 804, 806 may each include a view from a single wide-angle video sensor and/or a view generated by stitching together two or more views from two or more video sensors. In some embodiments, each of the views 802, 804, 806 may be extracted from a single 360° video feed.

The teleoperator view 800 of FIG. 8 is an example of a video feed (e.g., from which each of the views 802, 804, 806 may be extracted) that may display on a teleoperation workstation. In some embodiments, the focused view 802 may occupy a majority of the teleoperator view 800. For example, the focused view 802 may occupy approximately between 60 and 100 percent of the teleoperator view 800. In some embodiments, the amount of the teleoperator view 800 occupied by the focused view 802 may be based on a number of wide-angle views 804, 806 included in the teleoperator view 800 and/or may be adjustable in size by the teleoperator.

In some embodiments, the focused view 802 may be directed in a direction associated with an intended or expected trajectory of the driverless vehicle. For example, the processing device 208 may determine an intended trajectory for the driverless vehicle and may display a focused view that features an environment consistent with or in the same direction as the intended trajectory. Alternatively, or additionally, the focused view may be adjusted by the teleoperator, as described herein. For example, the teleoperator may want a view out the side of the driverless vehicle and may transmit a request to apply a distortion key to the processing device 208, such that the focused view may be adjusted to display out the side of the driverless vehicle based on the requested distortion key.

In some embodiments, the first wide-angle view804 includes a front wide-angle view that may be displayed in a top portion of the teleoperator view 800 and/or the second wide-angle view 806 includes a rear wide-angle view that may be displayed in a bottom portion of the teleoperator view 800. In some embodiments, each of the front and rear wide-angle views 804, 806 may include an approximate 180-degree FOV, such that together the front wide-angle view 804 and the rear wide-angle view 806 provide an approximate 360-degree FOV in the teleoperator view 800.

In some embodiments, the teleoperator may individually toggle the front wide-angle view 804 and/or the rear wide-angle view 806 to be enabled or disabled from the teleoperator view 800. For example, the teleoperator may disable the rear wide-angle view 806 which may result in the teleoperator view 800 displaying the front wide-angle view 804 and the focused view 802 without the rear wide-angle view 806, such that both or either of the front wide-angle view 804 and/or the focused view 802 may be larger as a result of not displaying the rear wide-angle view 806. Alternatively, the teleoperator may disable the front wide-angle view 804 which may result in the teleoperator view 800 displaying the focused view 802 and the rear view 806 without the front wide-angle view 804, such that both or either of the focused view 802 and/or the rear wide-angle view 806 may be larger as a result of not displaying the front wide-angle view 804.

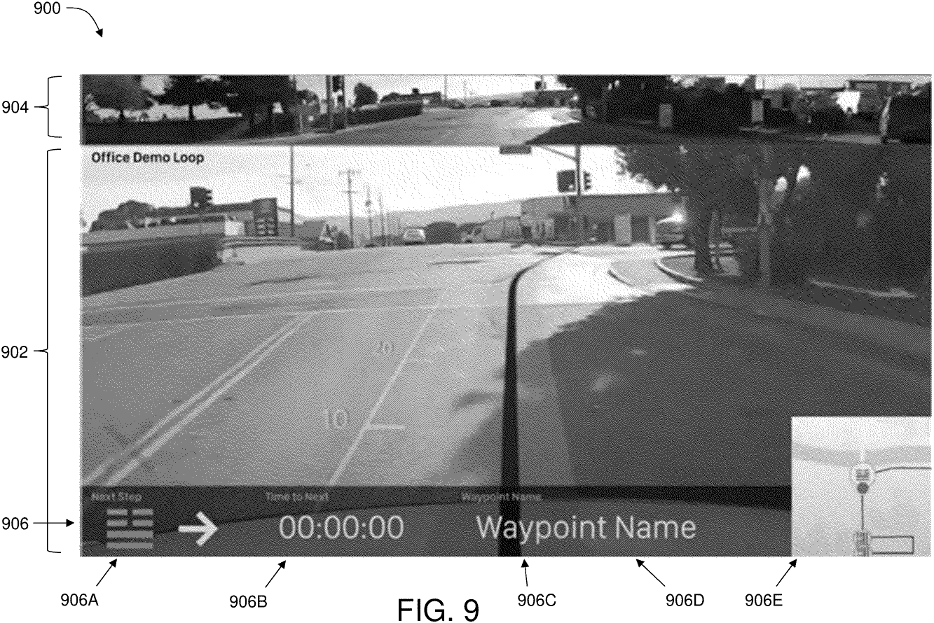

As an example of omitting one of the wide-angle views, FIG. 9 illustrates an example teleoperator view 900 that may include a focused view 902 and a front wide-angle view 904 without a rear wide-angle view, arranged in accordance with at least one embodiment described herein.

FIG. 9 further depicts some example embedded sensor data elements 906A-906E (hereinafter generically “embedded sensor data 906”) that may be included in the teleoperator view 900 and other teleoperator views described herein. In the illustrated embodiment, the embedded sensor data 906 has been overlayed on a portion of the focused view 902. In other embodiments, the embedded sensor data 906 may be overlayed on other views in the teleoperator view 900 (e.g., the front wide-angle view 904) and/or may be presented separate from any of the views in some other area of the teleoperator view 900. Some or all of the embedded sensor data 906 may be presented as a transparent overlay on a portion of either or both of the views 902, 904, as in the example of embedded sensor data elements 906A-906D. Alternatively or additionally, some or all of the embedded sensor data 906 may occlude a portion of either or both of the views 902, 904, as in the example of the embedded sensor data element 906E.

In the illustrated embodiment, the embedded sensor data element 906A includes a next step in a particular route being followed by the driverless vehicle. The embedded sensor data element 906B includes an approximate time for the occurrence of the next step of the embedded sensor data element 906A. The embedded sensor data element 906C includes an expected trajectory of the driverless vehicle within the environment represented in the focused view 902. The embedded sensor data element 906D includes a name of a waypoint toward which the driverless vehicle is headed. The embedded sensor data element 906E includes a map showing some or all of the particular route of the driverless vehicle.

One or more other embedded sensor data may alternatively or additionally be included in the teleoperator view 900 or other teleoperator views, such as obtained radar data, thermal infrared data, ultrasonic data, and/or other data that may be obtained from additional sensors associated with the driverless vehicle, as described herein. In some embodiments, the embedded sensor data elements may be toggled to display or not display by the teleoperator. For example, the teleoperator may toggle the expected trajectory embedded sensor data element 906C and/or the small map sensor data element 906E such that the focused view 902 is not overlaid or occluded by the expected trajectory embedded sensor data element 906C and/or the small map embedded sensor data element 906E, respectively.

In these and other embodiments, the processing device 208 may be configured to include the one or more views (e.g., the focused view, a first wide-angle view, and a second wide-angle view) and the embedded sensor data in a combined view that may be presented at the teleoperation workstation. For example, the processing device 208 may obtain and concatenate the focused video view and one or more wide-angle views, in addition to any embedded sensor data, into a combined view as part of a combined video feed and transmit the combined video feed to a teleoperation workstation for display to a teleoperator.

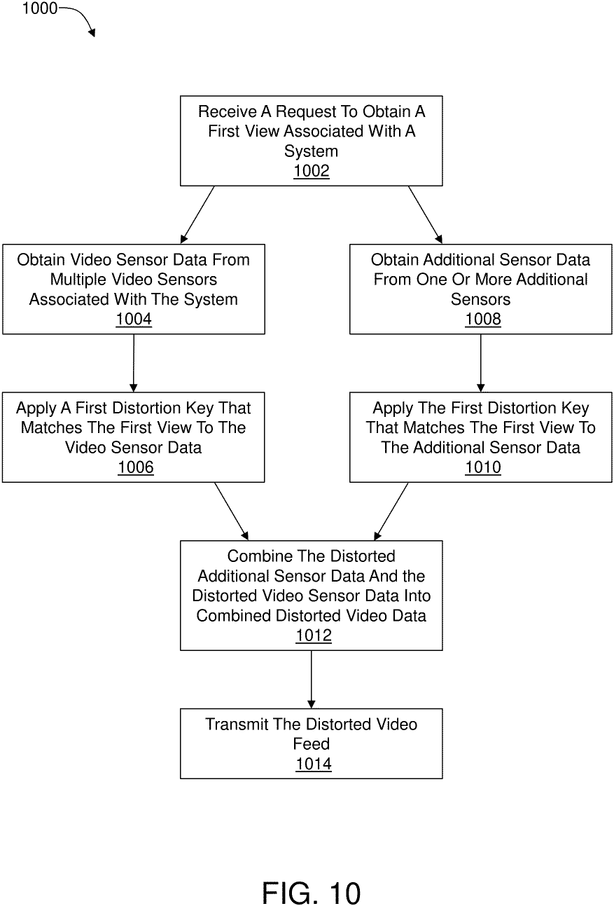

FIG. 10 is a flowchart of an example method 1000 for dynamic virtual sensor mapping, arranged in accordance with at least one embodiment described herein. The method 1000 may be performed by any of the systems or devices described herein, such as the first system 104, the second system 106, the system 200, a driverless vehicle, or the like. In some embodiments, the method 1000 may be embodied in code or other computer-readable instructions stored in a memory or other computer-readable storage media and executable by a processor, such as the processing device 208, to cause the processing device to perform or control performance of one or more of the functions or operations of the method 1000. The method 1000 may be performed by processing logic that may include hardware (circuitry, dedicated logic, etc.), software (such as is run on a computer system or a dedicated machine), or a combination of both, which processing logic may be included in, e.g., the processing device 208 of FIG. 2, the computing system of FIG. 12, or another device, combination of devices, or systems. The method 1000 may include one or more of blocks 1002, 1004, 1006, 1008, 1010, 1012, 1014, and/or 1016.

The method 1000 may begin at block 1002 where the processing logic may receive a request to obtain a first view associated with a system. In some embodiments, the first view may include a front view, left view, right view, rear view, and/or other view from a driverless vehicle or other system. In some embodiments, the first view may be associated with a first distortion key of multiple distortion keys.

The method 1000 may continue at block 1004 where the processing logic may obtain video sensor data from multiple video sensors that may be associated with the system. Obtaining the video sensor data from multiple video sensors may include stitching two or more different sets of video sensor data (e.g., two or more video feeds) together to generate wide-angle video sensor data. Adjacent video sensors may have FOVs that partially overlap such that the video sensor data of adjacent video sensors (hereinafter “adjacent video sensor data”) may have some overlap as well. Accordingly, stitching the two or more different sets of video sensor data together may include removing overlapping video sensor data.

The method 1000 may continue at block 1006 where the processing logic may apply a first distortion key to the video sensor data to generate distorted video sensor data. Applying the first distortion key to the video sensor data may include, e.g., linearizing a corresponding UV map, warping the UV map to expand one or more regions associated with the first view and to compress one or more other regions, or the like or any combination thereof. Warping the UV map to expand one or more regions and to compress one or more other regions may include vertically expanding a central portion of the UV map and vertically compressing upper and/or lower portions of the UV map. This may serve to expand a desired FOV in the vertical direction within the video data to generate warped or distorted video data (e.g., after painting a sequence of images of the video data onto the warped UV map to generate a sequence of warped 2D texture maps and outputting the sequence of warped 2D texture maps as the warped or distorted video data). Alternatively or additionally, warping the UV map to expand one or more regions and to compress one or more other regions may include horizontally expanding a central portion of the UV map and horizontally compressing lateral left and/or lateral right portions of the UV map. This may serve to expand a desired FOV (e.g., front view, left view, right view, rear view) in the horizontal direction within the video data to generate warped or distorted video data. In some embodiments, the first distortion key may be associated with the first view.

The method 1000 may continue at block 1008 where the processing logic may obtain additional sensor data from one or more additional sensors. For example, the additional sensor data may include path routing data, GPS data, radar data, vehicle speed data, vehicle directional data, objects in motion data relative to the vehicle, vehicle trajectory data, or the like or any combination thereof.

The method 1000 may continue at block 1010 where the processing logic may apply the first distortion key to the additional sensor data to generate warped or distorted additional sensor data. Applying the first distortion key to the additional sensor data may include formatting, arranging, or otherwise processing some or all of the additional sensor data for combination with the warped or distorted video sensor data generated at block 1006.

The method 1000 may continue at block 1012 where the processing logic may combine the warped or distorted video sensor data and the warped or distorted additional sensor data to generate combined warped or distorted video data.

The method 1000 may continue at block 1014 where the processing logic may transmit the combined warped or distorted video data. Transmitting the combined warped or distorted video data at block 1014 may include transmitting it to a teleoperator workstation or other receiving device where it may be rendered and displayed in a teleoperator view, such as the teleoperator views of FIGS. 8 and 9.

Modifications, additions, or omissions may be made to the method 1000 without departing from the scope of the present disclosure. For example, in some embodiments, the method 1000 may include any number of other blocks that may not be explicitly illustrated or described. Alternatively, or additionally, one or more blocks included in the flowchart may be performed sequentially, or in parallel, as applicable. For example, blocks 1004 and 1006 may be performed before blocks 1008 and 1010. Alternatively, block 1004 and block 1008 may be performed at substantially the same time.

In some embodiments, the method 1000 may include an additional block where the processing logic may transmit a request to the system. In some embodiments, the request to the system may include a request seeking assistance with an operation associated with the system. For example, in instances in which the system includes a driverless vehicle, the request for assistance may include a confirmation of an action related to the driverless vehicle, such as a turn operation. In some embodiments, the additional block may be configured to occur before block 1002. As another example, the method 1000 may include receiving a command (e.g., from a teleoperator) for the driverless vehicle to perform a desired operation and then controlling the driverless vehicle to perform the desired operation.

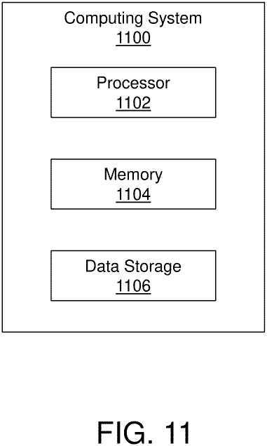

FIG. 11 illustrates a block diagram of an example computing system 1100, in accordance with at least one embodiment described in the present disclosure. The computing system 1100 may be configured to implement or direct one or more operations associated with dynamic virtual sensor mapping. The computing system 1100 may include a processor 1102, a memory 1104, and a data storage 1106. The processor 1102, the memory 1104, and the data storage 1106 may be communicatively coupled.

In general, the processor 1102 may include any suitable special-purpose or general-purpose computer, computing entity, or processing device including various computer hardware or software modules and may be configured to execute instructions stored on any applicable computer-readable storage media. For example, the processor 1102 may include a microprocessor, a microcontroller, a digital signal processor (DSP), an application-specific integrated circuit (ASIC), a Field-Programmable Gate Array (FPGA), hardware encoders and/or decoders, a graphics processing unit (GPU), hardware accelerators, functionally dedicated system, and/or any other digital or analog circuitry configured to interpret and/or to execute program instructions and/or to process data. Although illustrated as a single processor in FIG. 11, the processor 1102 may include any number of processors configured to, individually or collectively, perform or direct performance of any number of operations described in the present disclosure. Additionally, one or more of the processors may be present on one or more different electronic devices, such as different servers.

In some embodiments, the processor 1102 may be configured to interpret and/or execute program instructions and/or process data stored in the memory 1104, the data storage 1106, or the memory 1104 and the data storage 1106. In some embodiments, the processor 1102 may fetch program instructions from the data storage 1106 and load the program instructions in the memory 1104. After the program instructions are loaded into memory 1104, the processor 1102 may execute the program instructions.

For example, in some embodiments, one or more aspects of the dynamic virtual sensor mapping may be included in the data storage 1106 as program instructions. The processor 1102 may fetch the program instructions of a corresponding module from the data storage 1106 and may load the program instructions of the corresponding module in the memory. After the program instructions of the corresponding module are loaded into memory, the processor 1102 may execute the program instructions such that the computing system 1100 may implement the operations associated with the corresponding module as directed by the instructions.

The memory 1104 and the data storage 1106 may include computer-readable storage media for carrying or having computer-executable instructions or data structures stored thereon. Such computer-readable storage media may include any available media that may be accessed by a general-purpose or special-purpose computer, such as the processor 1102. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1102 to perform or control performance of a certain operation or group of operations.

Modifications, additions, or omissions may be made to the computing system without departing from the scope of the present disclosure. For example, in some embodiments, the computing system 1100 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of dynamic virtual sensor mapping comprising:
receiving a request to obtain a first view associated with a system, the first view being associated with a first distortion key of a plurality of distortion keys;
obtaining video sensor data from a plurality of video sensors associated with the system;
applying the first distortion key to the video sensor data to obtain distorted video sensor data;
obtaining additional sensor data from a plurality of additional sensors associated with the system;
applying the first distortion key to the additional sensor data to obtain distorted additional sensor data;
combining the distorted video sensor data together with the distorted additional sensor data to generate combined distorted video data; and
transmitting the combined distorted video data.

2. The method of claim 1, wherein the system comprises a driverless vehicle.

3. The method of claim 1, wherein obtaining the video sensor data from the plurality of video sensors comprises stitching together two or more different sets of video sensor data from two or more of the plurality of video sensors to generate video sensor data having a wider field of view (FOV) than the video sensor data of any single given one of the plurality of video sensors.

4. The method of claim 3, wherein:
the two or more different sets of video sensor data include first video sensor data generated by a first video sensor that has a first field of view (FOV) and second video sensor data generated by a second video sensor that has a second FOV that partially overlaps the first FOV; and
stitching together the two or more different sets of video sensor data to generate wide-angle video sensor data comprises removing a portion of the first or second video sensor data that overlaps a corresponding portion of the other of the second or first video sensor data.

5. The method of claim 1, wherein applying the first distortion key to the video sensor data to obtain distorted video sensor data comprises one or more of:
generating a UV map of a 3D model modeled as at least partially surrounding the system;
linearizing the UV map; or
warping the UV map or the linearized UV map.

6. The method of claim 1, wherein obtaining the additional sensor data from the plurality of additional sensors associated with the system comprises obtaining the additional sensor data from one or more of an accelerometer, a gyroscope, a global positioning system (GPS) device, a radar device, a LIDAR device, a thermal infrared device, or an ultrasonic device.

7. The method of claim 1, wherein applying the first distortion key to the additional sensor data to obtain distorted additional sensor data comprises formatting, arranging, or otherwise processing some or all of the additional sensor data for combination with the distorted video sensor data.

8. The method of claim 1, wherein transmitting the combined distorted video data comprises transmitting the combined distorted video data to a recipient device, the recipient device including a teleoperator workstation.

9. The method of claim 1, wherein the combined distorted video data includes an area of focus corresponding to the requested first view that has been expanded in the combined distorted video data compared to in the video sensor data obtained from the plurality of video sensors.

10. The method of claim 9, wherein the combined distorted video data further includes an unimportant area of little or no relevance to the system and that is outside the area of focus, the unimportant area having been compressed in the combined distorted video data compared to in the video sensor data obtained from the plurality of video sensors.

11. The method of claim 1, wherein the combined distorted video data includes both a focused view corresponding to the requested first view and a wide-angle view.

12. The method of claim 1, wherein:
the wide-angle view comprises a front wide-angle view with a field of view (FOV) of at least 180 degrees;
the combined distorted video data further includes a second wide-angle view; and
the second wide-angle view comprises a rear wide-angle video feed with a FOV of at least 180 degrees.

13. The method of claim 11, wherein when the combined distorted video data is rendered, the focused view occupies more of a display than the wide-angle video feed.

14. A non-transitory computer readable storage medium having computer-readable instructions stored thereon that are executable by a processor to perform or control performance of the method of claim 1.

15. A method, comprising
unwrapping a 3D model modeled as surrounding a driverless vehicle to generate a UV map;
receiving wide-angle video data captured by one or more video sensors of the driverless vehicle;
receiving a request for a primary view in the wide-angle video data from a requestor;
warping the UV map to expand a region corresponding to the primary view;
for each image in a sequence of images in the wide-angle video data, painting the image onto the warped UV map to generate a warped 2D texture map in which a relative size of the primary view is greater in the warped 2D texture map than in the image; and
transmitting warped video data comprising a sequence of warped 2D texture maps to the requestor.

16. The method of claim 15, further comprising linearizing the UV map prior to warping the UV map, wherein warping the UV map comprises warping the linearized UV map.

17. The method of claim 15, wherein:
the region corresponding to the primary view comprises a primary view region;
the method further comprises warping the UV map to compress another region that does not correspond to the primary view; and
the other region includes at least one of an upper region above the primary view region, a lower region below the primary view region, a left region to the left of the primary view region, or a right region to the right of the primary view region.

18. The method of claim 15, further comprising adding additional sensor data to the warped video data prior to transmitting the warped video data, the additional sensor data including at least one of path routing data, GPS data, radar data, driverless vehicle speed data, driverless vehicle directional data, objects in motion data relative to the driverless vehicle, or driverless vehicle trajectory data.

19. The method of claim 15, further comprising:
receiving a request for an additional view in the wide-angle video data from the requestor;
further warping the UV map to expand a region corresponding to the additional view;
for each image in a second sequence of images in the wide-angle video data, painting the image onto the further warped UV map to generate a further warped 2D texture map in which both a relative size of the primary view and a relative size of the additional view are greater in the further warped 2D texture map than in the image; and
transmitting warped video data comprising a sequence of further warped 2D texture maps to the requestor.

20. A non-transitory computer readable storage medium having computer-readable instructions stored thereon that are executable by a processor to perform or control performance of the method of claim 15.
